(19) United States
(12) Patent Application Publication
(10) Pub. No.: US 2013/0311070 A1
(43) Pub. Date: Nov. 21, 2013

(54) CONTROLLER FOR INTERNAL COMBUSTION ENGINE

(71) Applicants: Shigemichi UJIIE, Tokai-shi (JP); Takahiro ARIIE, Nisshin-shi (JP); Ikuo ANDO, Toyota-shi (JP); Toshitake SASAKI, Toyota-shi (JP)

(72) Inventors: Shigemichi UJIIE, Tokai-shi (JP); Takahiro ARIIE, Nisshin-shi (JP); Ikuo ANDO, Toyota-shi (JP); Toshitake SASAKI, Toyota-shi (JP)

(73) Assignees: TOYOTA JIDOSHA KABUSHIKI KAISHA, Toyota-shi (JP); AISAN KOGYO KABUSHIKI KAISHA, Obu-shi (JP)

(21) Appl. No.: 13/894,747

(22) Filed: May 15, 2013

(30) Foreign Application Priority Data
May 18, 2012 (JP) 2012-114776

(51) Int. Cl. F02D 41/14

(52) U.S. Cl. CPC F02D 41/14
USPC 701/108

(57) ABSTRACT

A controller includes an exhaust gas recirculation (EGR) system for performing EGR control, the system including an EGR passage for recirculating exhaust gas per cylinder and an EGR device for controlling a flow rate of the exhaust gas to be recirculated. The controller is arranged to perform internal combustion engine by learning control of an air-fuel ratio (A/F) during the EGR control. This controller includes a blocking determination section including first and second determination sections to determine blocking of the EGR passage in a specified cylinder. The blocking determination section is configured so that the first determination section makes preliminary determination of blocking of the EGR passage and the second determination section makes main determination of blocking of the EGR passage.

### CROSS-REFERENCE TO RELATED APPLICATIONS

This application is based upon and claims the benefit of priority from the prior Japanese Patent Application No. 2012-114776, filed May 18, 2012, the entire contents of which are incorporated herein by reference.

### BACKGROUND OF THE INVENTION

1. Field of the Invention

The present invention relates to a controller for internal combustion engine including an exhaust gas recirculation (EGR) system for recirculating part of exhaust gas to each cylinder.

2. Related Art

Conventionally, an engine system is arranged to return part of exhaust gas discharged from an engine to an intake system for the purpose of reduction of exhaust emission, improvement of fuel consumption, and others. This recirculation of exhaust gas to the intake system is performed by an exhaust gas recirculation system. To control exhaust gas recirculation and others, an exhaust gas recirculation (EGR) apparatus is used. This EGR device is generally configured such that an EGR pipe is connected between an exhaust pipe and an intake pipe of an engine, an EGR valve provided at some midpoint in the EGR pipe to recirculate part of the exhaust gas to the intake system.

If abnormality occurs in the EGR device, an appropriate amount of exhaust gas could not be recirculated to the intake system, resulting in deterioration of exhaust emission. Therefore, some techniques to detect the abnormality of the EGR device have been proposed. One of them is disclosed in Japanese patent application publication No. 2010-106785 (JP 2010-106785A). In this technique, in an EGR system provided for each cylinder, if abnormality occurs in any one of EGR devices individually provided in cylinders, an EGR amount in the cylinder with the abnormal EGR device becomes different from those in remaining normal cylinders during execution of EGR control to recirculate exhaust gas in each cylinder. Accordingly, an air-fuel ratio of the cylinder with the abnormal EGR device also becomes different from those of the normal cylinders. On the basis of this point, an air-fuel ratio of each cylinder is estimated based on output of an exhaust gas sensor during the EGR control, the presence/absence of abnormality of an EGR device of each cylinder is determined per cylinder based on whether or not the air-fuel ratio of each cylinder is outside a predetermined normal range. If there is a cylinder in which the air-fuel ratio is outside the normal range, the EGR device of the relevant cylinder is determined to be abnormal, and this abnormal EGR device is specified.

### SUMMARY OF INVENTION

### Problems to be Solved by the Invention

However, in the technique disclosed in JP 2010-106785A in which the abnormality of each EGR device is detected based on an air-fuel ratio, abnormalities in other parts or components than the EGR device, such as time degradation of an injector or clogging of an injection port, are likely to be detected. It is thus impossible to properly determine blocking of an EGR passage caused by clogging of the EGR passage in a specified cylinder due to deposits and abnormality of the EGR device.

Furthermore, since A/F control is not performed according to a blocked state of the EGR device in the specified cylinder, exhaust emission is liable to deteriorate.

The present invention has a purpose to provide a controller for internal combustion engine, configured to properly detect blocking of an EGR passage in a specified cylinder.

### Means of Solving the Problems

To achieve the above purpose, one aspect of the invention provides a controller for internal combustion engine, including an exhaust gas recirculation system for executing EGR control, the system including an EGR passage for recirculating exhaust gas for each cylinder and an EGR device for controlling a flow rate of the exhaust gas to be recirculated, the controller being configured to perform learning control of an air/fuel ratio (A/F) during the EGR control, wherein the controller further includes a blocking determination section provided with a first determination section and a second determination section to determine whether or not the EGR passage in a specified cylinder is blocked, the blocking determination section is configured so that the first determination section performs preliminary determination of blocking of the EGR passage and the second determination section performs main determination of blocking of the EGR passage.

### BRIEF DESCRIPTION OF THE DRAWINGS

FIG. 1 is schematic configuration diagram of an engine system including a controller according to an embodiment;

FIG. 2 is a flowchart showing details of EGR passage blocking determination processing and A/F control;

FIG. 3 is a graph showing a calculation map for A/F correction value; and

FIG. 4 is a timing chart showing one example of various control values and a state of an EGR system during the EGR passage blocking determination processing and the A/F control processing.

### DESCRIPTION OF EMBODIMENTS

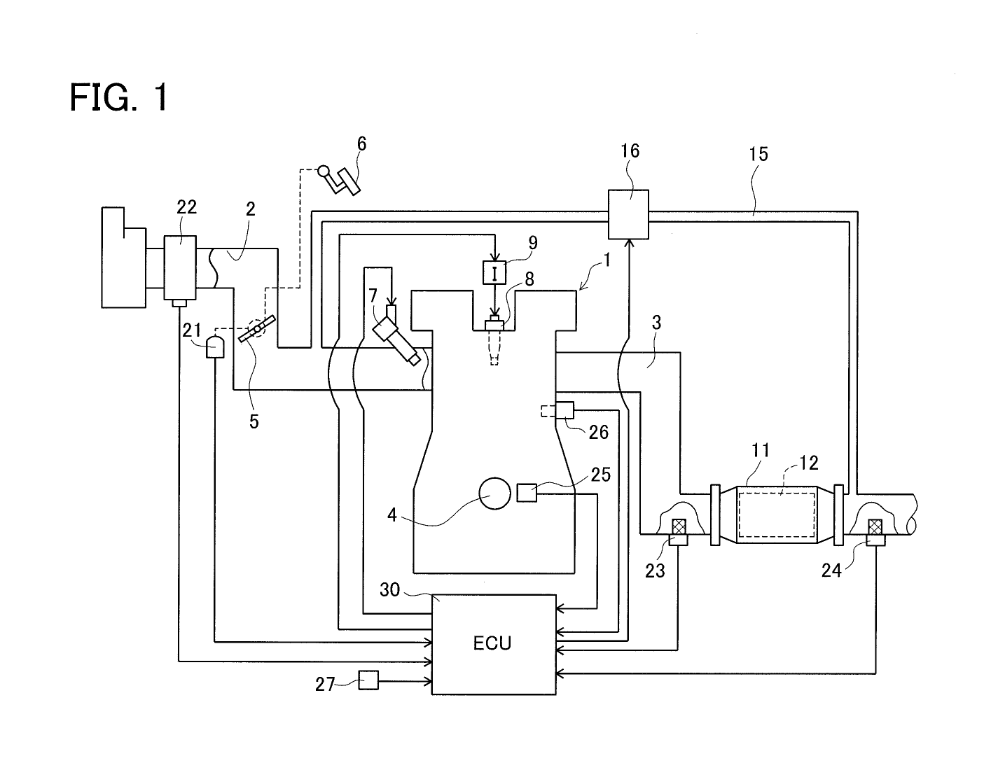

A detailed description of a preferred embodiment of a controller for internal combustion engine embodying the present invention will now be given referring to the accompanying drawings. The controller of the present embodiment is thus explained below referring to FIG. 1. FIG. 1 is a schematic configuration diagram of an engine system including the controller of the present embodiment.

As shown in FIG. 1, a multi-cylinder internal combustion engine (hereinafter, referred to as an “engine”) 1 having a well-known structure is configured such that a combustible air-fuel mixture of fuel and air supplied through an intake passage 2 is exploded and burnt in a combustion chamber of each cylinder and then the exhaust gas after combustion is discharged through the exhaust passage 3, thereby operating pistons (not shown) to rotate a crank shaft 4 to generate power.

A throttle valve 5 provided in the intake passage 2 is opened and closed to regulate an air amount (an intake air amount) QA allowed to flow through the passage 2 and be taken in each cylinder. This valve 5 is activated in sync with operation of an accelerator pedal 6 provided on a driver's side. A throttle sensor 21 provided for the throttle valve 5 detects an opening degree (a throttle opening degree) TA of the throttle valve 5 and outputs an electric signal representing a detected value thereof. An air flow meter 22 provided in the intake passage 2 measures the intake air amount QA flowing in the intake passage 2 and outputs an electric signal representing a measured value thereof.

A fuel injection valve (an injector) 7 provided for each cylinder injects and supplies fuel into an intake port of a corresponding cylinder. To each injector 7, fuel is supplied under pressure from a fuel supply system (not shown) including a fuel tank, a fuel pump, a fuel pipe, and others.

An ignition plug 8 provided for each cylinder in the engine 1 is operated to ignite in response to high voltage output from an igniter 9. Ignition timing of each ignition plug 8 is determined by output timing of high voltage by the igniter 9.

A catalytic converter 11 provided in the exhaust passage 3 internally contains a three-way catalyst 12 to clean or purify exhaust gas discharged from the engine 1. As well known, the three-way catalyst 12 simultaneously performs the oxidation of carbon monoxide (CO) and hydrocarbon (HC) contained in exhaust gas and the reduction (deoxidation) of nitrogen oxide (NOx), thereby converting three harmful gas components (CO, HC, and NOx) in exhaust gas into harmless carbon dioxide (CO₂), water vapor (H₂O), and nitrogen (N₂). Exhaust gas cleaning capacity of the three-way catalyst 12 is greatly influenced by an air-fuel ratio set for the engine 1. Specifically, when the air-fuel ratio (A/F) is lean, an amount of oxygen (O₂) after combustion is increased, thus activating an oxidizing action and inactivating a deoxidizing action. When those oxidizing and deoxidizing actions are balanced (when the air-fuel ratio approaches a theoretical value), the three-way catalyst 12 functions most effectively.

In the exhaust passage 3, an A/F sensor 23 is provided upstream of the three-way catalyst 12 and an O₂ sensor 24 is provided downstream of the same. The A/F sensor 23 is used to detect an oxygen concentration Ox of the exhaust gas discharged from the engine 1 to the exhaust passage 3 as an electric current value and converts the electric current value to a voltage value to detect an air-fuel ratio. The O₂ sensor 24 is used to detect an oxygen concentration Ox of the exhaust gas having passed through the three-way catalyst 12, and outputs an electric signal representing a detection value thereof.

The rotation speed sensor 25 provided in the engine 1 is used to detect an angular speed of the crank shaft 4, that is, the engine rotation speed NE, and outputs an electric signal representing a detection value thereof. The water temperature sensor 26 provided in the engine 1 is used to detect the temperature of cooling water (cooling-water temperature) THW flowing through the engine 1 and outputs an electric signal representing a detection value thereof. Further, the vehicle speed sensor 27 provided in a vehicle is used to detect the running speed (vehicle speed) SPD of the vehicle and outputs an electric signal representing a detection value thereof.

The electronic control unit (ECU) 30 receives various input signals output from the throttle sensor 21, air flow meter 22, A/F sensor 23, O₂ sensor 24, rotation speed sensor 25, water temperature sensor 26, and vehicle speed sensor 27. Based on those input signals, the ECU 30 executes A/F control, fuel injection control including fuel injection amount control and fuel injection timing control, and ignition timing control, and others to control each injector 7 and the igniter 9.

Herein, the A/F control is defined as operations to control each injector 7 based on at least an output signal from the A/F sensor 23 to feedback-control an actual A/F in the engine 1 to a target A/F. The fuel injection control is defined as operations to control each injector 7 according to an operating condition of the engine 1 and thereby control a fuel injection amount and a fuel injection timing. The ignition timing control is defined as operations to control the igniter 9 according an operating condition of the engine 1 and thereby control an ignition timing of each ignition plug 8.

In the present embodiment, the ECU 30 is one example of a blocking determination section (a first determination section and a second determination section) and a correction section of the invention. The ECU 30 is provided with well-known components such as a central processing unit (CPU), a read only memory (ROM), a random access memory (RAM), a backup RAM, and others. The ROM stores in advance predetermined control programs related to various controls mentioned above. In accordance with those programs, the ECU 30 executes the various controls and others.

To recirculate part of exhaust gas to back to an intake side for each cylinder of the engine 1, an EGR passage 15 is arranged to connect the exhaust passage 3 and the intake passage 2. The EGR passage 15 is provided with an EGR device (an EGR valve) 16 to regulate an EGR amount (a recirculation amount of exhaust gas). The EGR passage 15 extends in the form of a single path from the exhaust passage 3 to the EGR device 16 and branches into a plurality of paths (e.g., four paths in a 4-cylinder engine) each extending from the EGR device 16 to the intake passage 2.

Opening and closing operations of the EGR device 16 are controlled by the ECU 30. That is, the ECU 30 carries out an EGR control routine not shown to execute the EGR control (exhaust gas recirculation control) in which the EGR device 16 is opened and closed during engine operation, thereby recirculating part of exhaust gas to the intake side for each cylinder.

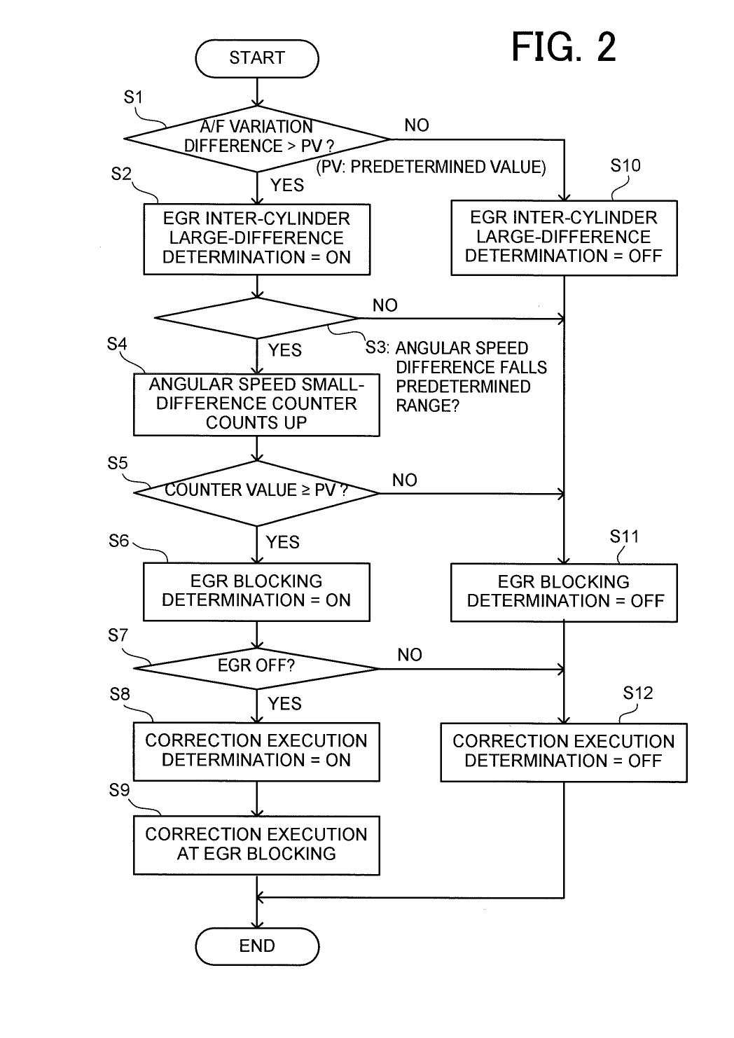

Successively, the blocking determination processing of the EGR passage and the A/F control in the aforementioned engine system are explained referring to FIG. 2. FIG. 2 is a flowchart showing the details of the blocking determination processing of the EGR passage and the A/F control. This processing routine is repeatedly performed at intervals of several milliseconds.

The ECU 30 firstly determines whether or not an A/F variation difference is larger than a predetermined value in each cylinder (step S1). In other words, it is determined whether or not the A/F variation difference falls within a normal range. To be concrete, it is determined whether or not the variation difference in A/F between an ON period and an OFF period of the EGR control is larger than the predetermined value set in advance. This is defined as “preliminary determination” of the EGR passage blocking by the first determination section of the invention.

When it is determined in this step S1 that the A/F variation difference of an i-th cylinder (e.g., i=1 to 4 in a 4-cylinder engine) falls within the normal range (S1: NO), the ECU 30 determines that the EGR passage of the i-th cylinder is not being blocked and thus turns OFF all of a flag indicating that a difference between EGR cylinders is large (“EGR inter-cylinder large-difference determination flag”), a flag indicating that the EGR passage is being blocked (“EGR blocking determination flag”), and a flag indicating that correction is executed (“correction execution flag”) (steps S10, S11, and S12), and then temporarily terminates this routine.

On the other hand, when it is determined that the A/F variation difference of the i-th cylinder is outside the normal range (S1: YES), the ECU 30 determines that the EGR passage of the i-th cylinder is possibly being blocked and thus turns ON the EGR inter-cylinder large-difference determination flag (step S2).

The ECU 30 thereafter determines whether or not a difference in engine rotation number (angular speed) in each cylinder is larger than a predetermined value (step S3). That is, it is determined whether or not the angular speed difference falls within a normal range. To be concreted, it is determined whether or not a difference in angular speed between the ON period and the OFF period of the EGR control falls within a predetermined range set in advance. This is defined as “main determination” of the EGR passage blocking by the second determination section of the invention.

Herein, the angular speed difference that occurs when abnormal or defective conditions are encountered is largely different between a case where blocking occurs in the EGR passage 15 and a case where time degradation, injection port clogging, and others occur in the injector 7. To be specific, when time degradation, injection port clogging, and others occur in the injector 7, the angular speed difference is rather larger than that when blocking occurs in the EGR passage 15. Accordingly, determination based on the angular speed difference enables accurate distinction on whether the blocking of the EGR passage 15 occurs or the time degradation, injection port clogging, and others occur in the injector 7. Thus, when the blocking of the EGR passage 15 is determined based on the angular speed difference, the blocked state of the EGR passage 15 in each cylinder can be correctly detected and hence a defective site can be specified.

When it is determined that the angular speed difference of the i-th cylinder is outside the predetermined range (S3: NO), the ECU 30 determines that the EGR passage 15 of the i-th cylinder is not blocked and thus turns OFF all of the EGR blocking determination flag and the correction execution flag (steps S11 and S12), and then temporarily terminates this routine.

On the other hand, when it is determined that the angular speed difference of the i-th cylinder falls within the predetermined range (S3: YES), the ECU 30 causes an angular speed small-difference counter to start counting up (step S4). Thereafter, it is determined whether or not a value of the angular speed small-difference counter is equal to or larger than a predetermine value (step S5). This is also defined as the main determination of the EGR passage blocking by the second determination section of the invention.

When it is determined in this step S5 that the value of the angular speed small-difference counter is equal to or larger than the predetermine value (S5: YES), the ECU 30 determines that the EGR passage 15 of the i-th cylinder is being blocked and thus turns ON the EGR blocking determination flag (step S6). By checking that the angular speed difference continues to fall within the predetermined range for a predetermined period of time as mentioned above, it is possible to prevent erroneous decision in the blocking determination of the EGR passage 15. Therefore, the blocked state of the EGR passage 15 can be detected more properly per cylinder.

When it is determined that the value of the angular speed small-difference counter is less than the predetermine value (S5: NO), the ECU 30 determines that the EGR passage 15 of the i-th cylinder is not being blocked and thus turns OFF all of the EGR blocking determination flag and the correction execution flag (steps S11 and S12), and then temporarily terminates this routine.

After the ECU 30 turns ON the EGR blocking determination flag in step S6, the ECU 30 determines whether or not the EGR control is not being executed (EGR OFF) (step S7). When it is determined in this step S7 that the EGR control is being executed (S7: NO), A/F control deviation is not problematic, and thus the ECU 30 turns OFF the correction execution flag (step S12) and temporarily terminates this routine.

On the other hand, when it is determined that the EGR control is not being executed (S7: YES), a request deviation occurs in the A/F control, the ECU 30 turns ON the correction execution flag (step S8) and then executes correction at the time of EGR blocking (step S9).

To be concrete, in S9, the ECU 30 corrects a target A/F and calculates an A/F correction value based on an estimated imbalance rate at the time of EGR passage blocking, and corrects an A/F learning value. Herein, the estimated imbalance rate is a value that becomes larger or smaller (i.e., that monotonically increases or monotonically decreases) as the degree of difference (degree of imbalance) in inter-cylinder air-fuel ratio is larger. This value is obtained based on an output value of the A/F sensor 23.

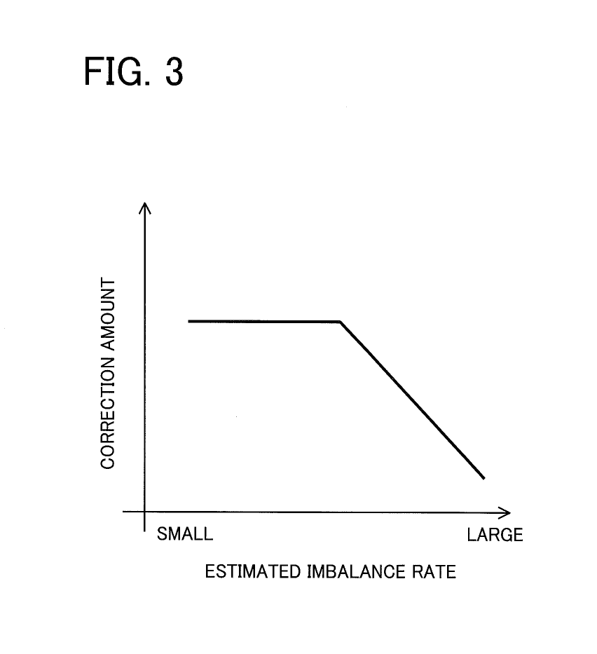

In the present embodiment, for example, as shown in FIG. 3, the A/F correction value is calculated to become gradually smaller as the estimated imbalance rate increases after the estimated imbalance rate exceeds a predetermined value. The target A/F is similarly corrected according to the estimated imbalance rate. In this way, the A/F learning value is finally corrected.

As above, the A/F control can be performed appropriate to the blocked state of the EGR passage. As a result, even when the EGR passage is blocked, the A/F learning value can be maintained within an appropriate range. It is therefore possible to prevent deterioration of exhaust emission when the EGR passage is blocked.

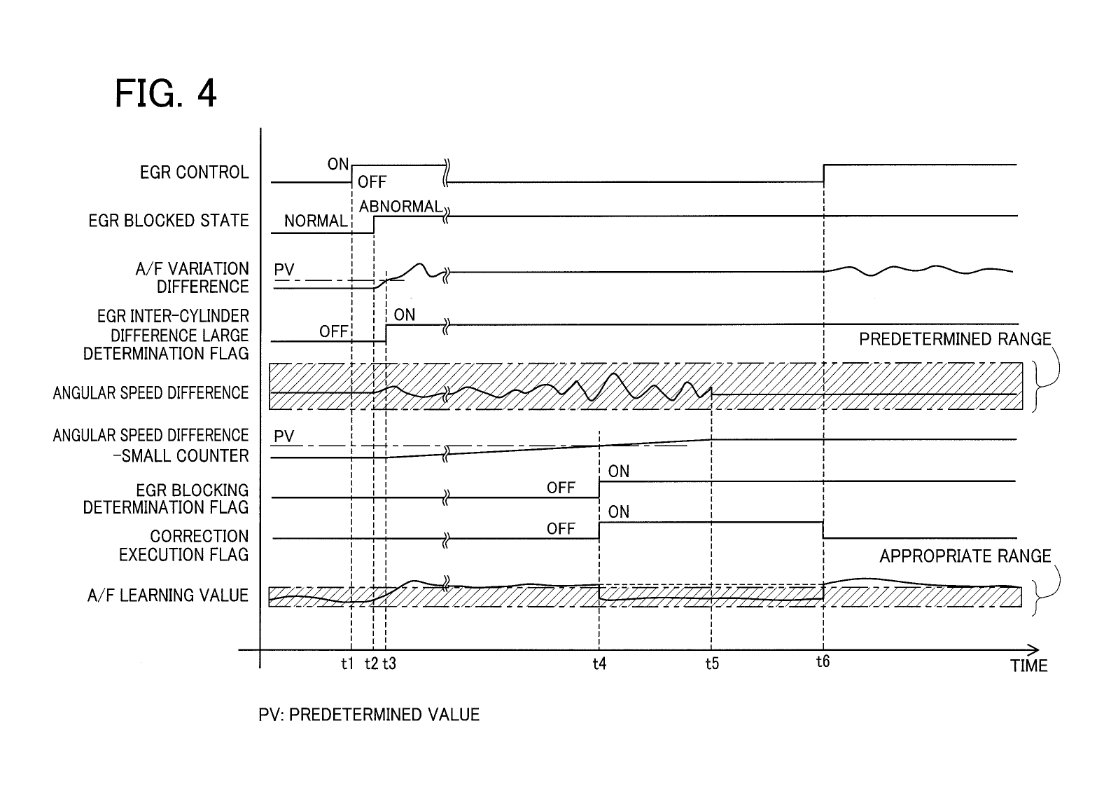

Next, various control values and the EGR system during execution of during the above processing will be explained referring to FIG. 4. FIG. 4 is a timing chart showing one example of various control values and the state of the EGR system in the EGR passage blocking determination processing and the A/F control processing.

Before a time t1, the EGR control is not executed. At the time t1, the EGR control is started (EGR ON). At a time t2, thereafter, it is determined that the EGR passage of the i-th cylinder is blocked. Until the time t2, the A/F variation difference is smaller than the predetermined value and all of the EGR inter-cylinder large-difference determination flag, EGR blocking determination flag, and correction execution flag are turned OFF (S1: NO, S10, S11, and S12 in FIG. 2).

When the EGR passage of the i-th cylinder is blocked at the time t2, the A/F variation difference becomes gradually larger. At a time t3, when the A/F variation difference exceeds the predetermined value, the EGR inter-cylinder large-difference determination flag is turned ON (S1: YES, S2 in FIG. 2). At that time, the angular speed difference of the i-th cylinder falls within the predetermined range, and thus the angular speed small-difference counter is started to count up (S3: YES, S4 in FIG. 2). At the time t3, the value of the angular speed small-difference counter does not reach a predetermined value and thus the EGR blocking determination flag and the correction execution flag remain OFF (S5: NO, S11, S12 in FIG. 2).

At a time t4, when the value of the angular speed small-difference counter becomes equal to or larger than the predetermined value, the EGR blocking determination flag is turned ON (S5: YES, S6 in FIG. 2). At that time, the EGR control is not being executed and thus the correction execution flag is turned ON (S7: YES, S8 in FIG. 2). Accordingly, the A/F correction control at the time of EGR passage blocking is conducted (S9 in FIG. 2). Thus, the A/F control can be performed appropriate to the blocked state of the EGR passage in the i-th cylinder.

In the conventional art that does not carry out the above A/F correction control, the A/F learning value does not fall within the appropriate range as indicated by a broken line in FIG. 4. Thus, exhaust emission is deteriorated.

In the present embodiment, in contrast, the A/F correction control at the time of EGR passage blocking mentioned above is executed, so that the A/F learning value falls within the appropriate range, thereby preventing deterioration in exhaust emission.

Thereafter, at the time t5, the angular speed small-difference counter terminates counting. At a time t6, the EGR control is started again. Thus, the correction execution flag is turned OFF (S7: NO, S12 in FIG. 2). Accordingly, the A/F correction control at the time of EGR passage blocking is completed.

While the EGR control is being executed, in which learning of A/F in the EGR passage blocked state is being performed, the exhaust emission will not deteriorate even when the A/F learning value does not fall within the appropriate range.

According to the controller of the present embodiment as explained in detail above, the ECU 30 performs the preliminary determination of EGR passage blocking based on whether or not the A/F variation difference between the ON period and the OFF period of the EGR control is larger than the predetermined value, and then executes the main determination of EGR passage blocking by checking that the angular speed difference between the ON period and the OFF period of the EGR control continues to fall within the predetermined value for the predetermined period of time. This makes it possible to prevent erroneous determination in the blocking determination of the EGR passage 15, and further more properly detect the blocked state of the EGR passage 15 per cylinder.

The above embodiment is a mere example and does not limit the invention. The present invention may be embodied in other specific forms without departing from the essential characteristics thereof.

1. A controller for internal combustion engine, including an exhaust gas recirculation system for executing EGR control, the system including an EGR passage for recirculating exhaust gas for each cylinder and an EGR device for controlling a flow rate of the exhaust gas to be recirculated, the controller being configured to perform learning control of an air/fuel ratio (A/F) during the EGR control,
wherein the controller further includes a blocking determination section provided with a first determination section and a second determination section to determine whether or not the EGR passage in a specified cylinder is blocked,
the blocking determination section is configured so that the first determination section performs preliminary determination of blocking of the EGR passage and the second determination section performs main determination of blocking of the EGR passage.

2. The controller for internal combustion engine according to claim 1,
wherein the first determination section makes the preliminary determination based on a variation difference in A/F between an ON period and an OFF period of the EGR control, and
the second determination section makes the main determination based on a difference in engine rotation number between the ON period and the OFF period of the EGR control.

3. The controller for internal combustion engine according to claim 2,
wherein the first determination section makes the preliminary determination that the EGR passage is being blocked when the A/F variation difference becomes equal to or larger than a predetermined value set in advance, and
the second determination section makes the main determination that the EGR passage is being blocked when the difference in engine rotation number falls within a predetermined range set in advance for a fixed period of time after the preliminary determination is made by the first determination section.

4. The controller for internal combustion engine according to claim 1, further including a correction section for correcting a target A/F when the blocking determination section determines that the EGR passage is being blocked during execution of the EGR control, and calculates an A/F correction value to bring an actual A/F to the corrected target A/F.

5. The controller for internal combustion engine according to claim 4, wherein the correction section corrects the target A/F and calculates the A/F correction value based on the estimated imbalance rate at the time of EGR passage blocking.

6. The controller for internal combustion engine according to claim 5, wherein the correction section calculates the estimated imbalance rate to become gradually smaller as the estimated imbalance rate increases after the estimated imbalance rate exceeds a predetermined value.
